(19) United States
(12) Patent Application Publication
(10) Pub. No.: US 2024/0316989 A1
(43) Pub. Date: Sep. 26, 2024

(54) DUPLEX CORD FOR USE AS A REINFORCEMENT IN A BELT BANDAGE OF A PNEUMATIC VEHICLE TYRE

(71) Applicant: Continental Reifen Deutschland GmbH, Hannover (DE)

(72) Inventors: Claudia Grote, Hannover (DE); Thomas Kramer, Herford (DE); Wolfgang Reese, Peine (DE)

(73) Assignee: Continental Reifen Deutschland GmbH, Hannover (DE)

(21) Appl. No.: 18/579,493

(22) PCT Filed: Jul. 11, 2022
(86) PCT No.: PCT/DE2022/200153

§ 371 Date: Jan. 15, 2024

(30) Foreign Application Priority Data
Jul. 15, 2021 (DE) 10 2021 207 531.2

(51) Int. Cl. B60C 9/00; D02G 3/04; D02G 3/36; D02G 3/48

(52) U.S. Cl. CPC B60C 9/005; B60C 9/0042; D02G 3/047; D02G 3/36; D02G 3/48; B60C 2009/0071; D10B 2401/063

(57) ABSTRACT

The invention relates to a duplex cord for use as strength member in a belt bandage of a pneumatic vehicle tire, consisting of exactly two yarns that are twisted together at the ends, wherein the first yarn has a Z value of 600 mN/tex or more, and wherein the second yarn has a Z value of 75 mN/tex or less and a Y value of 150 mN/tex or less, where Z is the force normalized to the linear yarn density at which an elongation of 1% is obtained in the force-elongation diagram, where Y is the force normalized to the linear yarn density at which an elongation of 4% is obtained in the force-elongation diagram, and where the quotient X of the linear density of the first yarn divided by the linear density of the second yarn is in the range from 1.0 to 1.3.

### BRIEF SUMMARY

The invention relates to a duplex cord for use as strength member in a belt bandage of a pneumatic vehicle tire, to a composite material comprising corresponding duplex cords, to a vulcanized composite material producible therefrom, to a corresponding vehicle tire made from these materials, and to the use of corresponding duplex cords in the belt bandage of a pneumatic vehicle tire for improving the high-speed properties and the rolling resistance properties.

### DETAILED DESCRIPTION

The development and manufacture of high-performance vehicle tires is an area in which there is a constant need to further improve the components known from the prior art. A tire component that is particularly important in optimizing the high-speed properties of vehicle tires is what are known as reinforcing cords, which are used as strength members in the belt bandage of a pneumatic vehicle tire. These reinforcing cords serve, inter alia, to ensure the necessary stiffness in the tire and, with their mechanical properties, significantly influence the subsequent running properties of the tire, in particular through the hysteresis characteristics and the profile resulting for the reinforcing cords in the force-elongation diagram.

In the prior art, for particularly high-performance pneumatic vehicle tires, which are optimized in particular with respect to high-speed performance, high-modulus triplex cords are currently used, in which two aramid yarns with relatively high modulus and a low-modulus nylon yarn are twisted together. The helical twisting allows here an extension of the aramid at relatively low forces, which is necessary in order not to cause any unwanted deformation in the manufacturing process of the vehicle tires, especially when introducing them into the mold.

Even though the established triplex cords enable the manufacture of pneumatic vehicle tires with advantageous performance characteristics, these triplex cords are also regularly perceived as disadvantageous. The production from three individual yarns requires a comparatively complex and cost-intensive two-stage twisting process in which the rather brittle aramid is subjected in total two times to mechanical stress, which should in principle rather be avoided. In addition, triplex cords regularly have a comparatively high thickness, which in the later operation of the vehicle tire is perceived as a disadvantage with respect to the temperature development and thus also ultimately the high-speed performance. In addition, the hysteresis characteristics of such triplex cords in some cases worsen the rolling resistance of the corresponding vehicle tires.

As an alternative to triplex cords, the prior art also discloses what are known as duplex cords, in which only two yarns are twisted together and which are therefore much simpler to produce. Duplex cords are also frequently thinner than triplex cords here. The disadvantage of duplex cords, which in many cases limits their use in high-performance tires for high-speed applications, is that the force-elongation characteristics are regularly perceived as being disadvantageous compared to triplex cords, with the necessary high modulus of the entire cord not being achieved in particular.

Duplex cords and triplex cords are known in principle from the prior art.

DE 10 2008 037 615 A1, for example, discloses hybrid cords for use as strength members in a belt bandage with specific first-twisting numbers of the respective yarns.

EP 1 878 591 B1 discloses a ply of strength members embedded in an unvulcanized rubber mixture for the belt bandage of pneumatic vehicle tires, wherein in the strength members a maximum linear density is defined for the yarn with the high modulus of elasticity.

EP 2 055 817 A1 discloses a tire with at least one cord, wherein the yarns of the cord are formed from specific materials.

EP 2 065 222 B1 discloses a pneumatic vehicle tire with reinforcing cords, wherein the high-modulus yarn has an elastic modulus of not less than 10 000 MPa and the low-modulus yarn is nylon 46.

EP 3 006 228 B1 discloses a hybrid cord, wherein the high-modulus yarn is a filament yarn and the low-modulus yarn is a staple fiber yarn.

EP 3 196 343 B1 discloses a hybrid cord with a core-covering structure, wherein the hybrid cord is defined by a specific twist number and also a specific tensile strength and a specific Young's modulus of the high-modulus yarn.

EP 3 365 187 B1 discloses a carcass for pneumatic tires with a multiplicity of two-ply hybrid cords, wherein the hybrid cords have a specific nylon content, a specific linear overall density value and a predetermined degree of twisting.

US 2018/0099529 A1 discloses a reinforcing element, wherein a high-modulus yarn and a low-modulus yarn are twisted together in a specific manner.

WO 2014/104680 A1 discloses a hybrid cord comprising twisted nylon and twisted aramid yarn which in turn are twisted together at the ends.

WO 2018/075305 A1 discloses a hybrid cord in which a nylon yarn and an aramid yarn have the same twist and an approximately equal length.

The object of the present invention was to overcome or at least to reduce the disadvantages known from the prior art.

In particular, the object of the present invention was to specify a reinforcing cord for use as strength member in a belt bandage of a pneumatic vehicle tire, which reduces or even completely eliminates the disadvantages known for triplex cords.

In particular, the reinforcing cord to be specified should be easier and more cost-effective to produce than corresponding triplex cords while having force-elongation characteristics that are as similar as possible. In addition, the reinforcing cord to be specified should ideally have a relatively small diameter and possess a relatively low value for the overall linear density while having force-elongation characteristics that are as similar as possible.

Compared to the duplex cords known from the prior art, the object was on the other hand to specify a reinforcing cord which has exceptional force-elongation properties corresponding to those of triplex cords known from the prior art.

In this respect, the object was to specify a reinforcing cord which is particularly suitable for use in such pneumatic vehicle tires that are optimized for high-speed applications.

In this context, it was a supplementary requirement that the reinforcing cord to be specified should ideally be producible using customary production processes and should have the highest possible chemical compatibility with the customary sulfur-curable compositions used in pneumatic vehicle tires.

It was a supplementary object of the present invention that the reinforcing cord to be specified should lead to improved rolling properties, in particular to a more favorable rolling resistance.

The inventors of the present invention have now discovered that the above objects can surprisingly be achieved if a duplex cord as defined in the appended claims is provided as reinforcing cord. In particular, the inventors of the present invention have discovered that favorable force-elongation characteristics for the duplex cord can be surprisingly achieved if, in comparison to the higher-modulus yarns such as aramid typically used from the prior art, a different yarn is used which has a markedly increased modulus compared to the prior art.

In this respect, however, the inventors of the present invention have also discovered that, in order to obtain force-elongation properties comparable to triplex cords known from the prior art, a certain ratio between the linear densities of the two yarns used in the duplex cord must also be established, meaning that the very high-modulus first yarn should have a linear density that is not too much higher than that of the second yarn.

The objects mentioned above are correspondingly achieved by duplex cords, composite materials, vulcanized composite materials, vehicle tires and uses as defined in the claims. Preferred configurations according to the invention will emerge from the subclaims and from the statements below.

Those features of duplex cords, composite materials, vulcanized composite materials, vehicle tires and uses according to the invention which are described below as being preferred are combined in particularly preferred embodiments with other features described as being preferred. Combinations of two or more of the embodiments that are described below as being particularly preferred are therefore very particularly preferred. Embodiments are likewise preferred in which a feature described as being preferred to a certain degree is combined with one or more further features described as being preferred to a certain degree. Features of preferred composite materials, vulcanized composite materials, vehicle tires and uses according to the invention emerge from the features of preferred duplex cords.

The invention relates to a duplex cord for use as strength member in a belt bandage of a pneumatic vehicle tire, consisting of exactly two yarns that are twisted together at the ends,
wherein the first yarn has a Z value of 600 mN/tex or more, and
wherein the second yarn has a Z value of 75 mN/tex or less and a Y value of 150 mN/tex or less,
where Z is the force normalized to the linear yarn density at which an elongation of 1% is obtained in the force-elongation diagram,
where Y is the force normalized to the linear yarn density at which an elongation of 4% is obtained in the force-elongation diagram, and
where the quotient X of the linear density of the first yarn divided by the linear density of the second yarn is in the range from 1.0 to 1.3.

The duplex cord according to the invention is suitable for use as strength member in a belt bandage of a pneumatic vehicle tire and is particularly preferred for this use.

The duplex cord consists exactly of two yarns that are twisted together at the ends. This means that no further yarn is present in the duplex cord.

According to the invention, the first yarn has a specific Z value, where Z is the force normalized to the linear yarn density at which an elongation of 1% is obtained in the force-elongation diagram. The value Z accordingly correlates with the modulus of the yarn, with the chosen definition via the chord modulus being a representation of this property that is customary for a person skilled in the art and allows a particularly meaningful definition of the materials. The first yarn is therefore a particularly high-modulus yarn, which in particular has a higher chord modulus than the aramid yarns used in prior art reinforcing cords.

The second yarn is a low-modulus yarn. In accordance with the understanding of a person skilled in the art, not just the value Z for the chord modulus at an elongation of 1% but also the value Y as chord modulus at an elongation of 4% are specified for sufficient definition of the second yarn.

The values Y and Z are determined in accordance with the understanding of a person skilled in the art from the force-elongation diagram and can be calculated using the known linear density of the yarns. In the context of the present invention, the force-elongation diagram used for the determination of Y and Z is recorded with a tensile testing machine from Zwick in accordance with the standard ASTM D885/D885M of 2014.

In the duplex cord according to the invention, the linear densities of the first and of the second yarn are also specifically matched to each other in order to achieve force-elongation characteristics which correspond to those of a triplex cord. This is done via the quotient X, which is calculated by dividing the linear density of the first yarn by the linear density of the second yarn. According to the assessment by the inventors, the quotient X must lie within the specified range in order to reliably obtain a duplex cord according to the invention that achieves the objects set.

The term linear density is clear to a person skilled in the art in the field of textiles. This parameter correlates with the thickness of a yarn and represents a mass per unit length commonly indicated with the unit tex or dtex.

With duplex cords according to the invention, the objects defined above are achieved and reinforcing cords are obtained as strength members, the use of which in the belt bandage of a pneumatic vehicle tire makes it possible to obtain high-performance tires that have exceptional high-speed properties.

The inventors of the present invention have come to the assessment that it is particularly advantageous if the ratio of the linear densities is set to very specific values, where the high-modulus first yarn should ideally have values that lie within a certain range just above the linear density of the second yarn. In particular, in the case of duplex cords according to the invention in which the quotient X is about 1.15, force-elongation characteristics were observed which were particularly similar to those of a triplex cord acting as a reference system. Preference is correspondingly given to a duplex cord according to the invention, wherein the quotient X of the linear density of the first yarn divided by the linear density of the second yarn is in the range from 1.05 to 1.25, preferably in the range from 1.1 to 1.2, particularly preferably in the range from 1.13 to 1.17.

The inventors of the present invention have discovered that it is particularly advantageous to choose a particularly high-modulus first yarn, since as a result it is surprisingly possible to obtain particularly high-performance duplex cords the resulting force-elongation characteristics of which are advantageously comparable to those of triplex cords in which several yarns made from conventional high-modulus material, for example aramid, are used. Preference is namely given to a duplex cord according to the invention, wherein the first yarn has a Z value of 650 mN/tex or more, preferably 700 mN/tex or more.

In addition, the inventors propose selecting the second yarn with a modulus that is as small as possible, so that there is deliberately a large difference between the moduli of the two yarns used. With a corresponding construction, duplex cords according to the invention which can be processed particularly easily and efficiently are routinely obtained. Preference is consequently given to a duplex cord according to the invention, wherein the second yarn has a Z value of 65 mN/tex or less, preferably of 55 mN/tex or less, and/or wherein the second yarn has a Y value of 140 mN/tex or less, preferably of 135 mN/tex or less.

In the course of the development work, the inventors of the present invention have succeeded in identifying particularly suitable materials that can be used as the first or second yarn in duplex cords according to the invention. For the high-modulus yarn, specific, particularly high-modulus aramid (which is also referred to as HM aramid) that is optimized with respect to its modulus, and also the material known as Zylon, have proven here in particular to be suitable. These materials differ significantly in their modulus from the regular aramid typically used in the prior art for duplex cords. With regard to the low-modulus second yarn, polyamides in particular have proven to be suitable, with the material known as nylon being particularly preferred, in particular nylon PA6.6.

Preference is therefore given to a duplex cord according to the invention, wherein the first yarn comprises a material selected from the group consisting of aromatic polyamides, in particular poly(p-phenyleneterephthalamide), and polyoxazoles, in particular poly(p-phenylene-2,6-benzobisoxazole), the first yarn preferably consisting of this material. Particular preference is therefore given to a duplex cord according to the invention, wherein the first yarn consists of poly(p-phenyleneterephthalamide) or poly(p-phenylene-2,6-benzobisoxazole). The specific configuration of these materials as a particularly high-modulus embodiment ensues here from the Z value defined above.

Accordingly, preference is also given to a duplex cord according to the invention, wherein the second yarn comprises a material selected from the group consisting of polyamides, in particular polyhexamethyleneadipamide, the second yarn preferably consisting of this material.

According to the assessment by the inventors, to obtain particularly high-performance duplex cords according to the invention, the first and the second yarn should have linear densities the values of which are each above 1000 dtex, with particular upper limits being proposed by the inventors in view of the thickness of the resulting duplex cord, above which limits more intense heat development can arise more readily in the later use in the vehicle tire. In this respect, preference is given to a duplex cord according to the invention, wherein the first yarn has a linear density in the range from 1000 to 3000 dtex, preferably in the range from 1500 to 2000 dtex. Preference is likewise given to a duplex cord according to the invention, wherein the second yarn has a linear density in the range from 1000 to 2000 dtex, preferably in the range from 1300 to 1700 dtex.

Proceeding from the statements made above, it is the assessment of the inventors that the overall linear density of the duplex cord should ideally also lie in a particular, middle range. Preference is therefore given to a duplex cord according to the invention, wherein the duplex cord has a linear density in the range from 2500 to 4000 dtex, preferably in the range from 2800 to 3500 dtex.

In the course of development, the inventors of the present invention were able to identify a force-elongation profile which can be established with duplex cords according to the invention and which is particularly similar in its characteristics to that of triplex cords for high-speed applications. Such preferred duplex cords can accordingly be used to produce vehicle tires that are particularly advantageous for these high-speed applications and in particular had the necessary stiffness.

Preference is given to a duplex cord according to the invention, wherein the duplex cord has the following force-elongation properties:
13 to 17 N at 1% elongation,
29 to 33 N at 2% elongation,
57 to 63 N at 3% elongation,
102 to 112 N at 4% elongation,
160 to 180 N at 5% elongation,
240 to 280 N at 6% elongation.

Even though, according to the assessment by the inventors, the duplex cords according to the invention are comparatively flexible with respect to the twisting between the yarns, the inventors propose, on the basis of the knowledge available to them, specific twist factors that lead to particularly suitable duplex cords according to the invention. Preference is namely given to a duplex cord according to the invention, wherein the duplex cord has a twist factor in the range from 150 to 200, preferably in the range from 170 to 230, particularly preferably in the range from 185 to 215.

In the light of the statements above, it is evident that the invention also relates to a composite material comprising one or more of the duplex cords according to the invention. The invention therefore also relates to a composite material, in particular for use in the manufacture of a belt bandage of a pneumatic vehicle tire, comprising one or more duplex cords according to the invention which are at least partially covered by a crosslinkable rubberization mixture.

In accordance with the understanding of a person skilled in the art, the crosslinkable rubberization mixtures used here can be the rubberization mixtures known from the prior art that are routinely used in the production of pneumatic vehicle tires. In this respect, it can also be considered an advantage of the duplex cords according to the invention that they permit a choice of material that has high chemical compatibility with the crosslinkable rubberization mixtures known from the prior art.

The advantageous properties of the composite material according to the invention can be seen in particular in the fact that it can be used in the production of pneumatic vehicle tires which have a favorable rolling resistance and the stiffness necessary for high-speed applications, with optimized hysteresis characteristics. In this case, the composite material according to the invention has very similar properties to those materials employed by triplex cords, but is usually markedly more favorable to produce as a result of the simpler production process here.

It has proven to be particularly advantageous to use two or more duplex cords according to the invention in corresponding composite materials according to the invention and to arrange them preferably substantially parallel to one another. The parameter familiar to a person skilled in the art for describing a corresponding arrangement is the EPDM here, which specifies the number of reinforcing cords per decimeter along a direction perpendicular to the longitudinal axis of the duplex cords. Preference is accordingly given to a composite material according to the invention, wherein the composite material comprises two or more duplex cords according to the invention, wherein the duplex cords are preferably arranged substantially parallel to one another.

Preference is given to a composite material according to the invention, wherein the duplex cord(s) is/are completely covered by the crosslinkable rubberization mixture, wherein the duplex cord(s) is/are preferably completely surrounded by the crosslinkable rubberization mixture.

Vulcanizing the composite material according to the invention makes it possible to obtain a vulcanized composite material that can be used in pneumatic vehicle tires according to the invention. The composite material according to the invention/the vulcanized composite material can be used to produce belt bandages/vehicle tires that have exceptional high-speed properties and an advantageous rolling resistance, wherein the duplex cords according to the invention ensure the necessary stiffness and due to the lower diameter compared to comparable triplex cords contribute to a reduction in the buildup of heat in the corresponding vehicle tires.

The invention thus also relates to a vulcanized composite material, producible by vulcanization of a composite material according to the invention.

The invention also discloses a belt bandage for use in the manufacture of a pneumatic vehicle tire, comprising one or more duplex cords according to the invention, a composite material according to the invention or a vulcanized composite material according to the invention.

The invention also relates to a vehicle tire, in particular pneumatic vehicle tire, comprising one or more duplex cords according to the invention, a composite material according to the invention or a vulcanized composite material according to the invention.

Lastly, the invention also relates to the use of one or more duplex cords according to the invention in the belt bandage of a pneumatic vehicle tire for improving the high-speed properties and the rolling resistance properties.

Preferred embodiments of the invention are explained and described in more detail below with reference to the accompanying experimental data.

Provided as reference system V1 was a triplex cord comprising two yarns of regular aramid and one yarn of nylon with a twist level of 320 T/m. The linear density of the aramid yarns used was 1680 dtex and the linear density of the nylon was 470 dtex.

In the duplex cord E1 according to the invention, a high-modulus aramid (HM aramid) with a linear density of 1610 dtex was used and was end-twisted with a nylon yarn with 1400 dtex.

The Z value of the high-modulus aramid was 678 mN/tex. The Z value of the nylon was 50 mN/tex and the Y value of the nylon was 135 mN/tex. The corresponding values were determined from the force-elongation diagrams of the yarns, which were determined with a tensile testing machine from Zwick in accordance with the standard ASTM D885/D885M of 2014.

The corresponding reinforcing cords were processed in composite materials into belt bandages and also used in 245/40 ZR18 (“extreme contact” DWS06) tires. The tires with duplex cords according to the invention exhibited a lower rolling resistance and comparable high-speed properties here.

It is evident from the following table 1 that the force required for a specific elongation (LASE; “load at specified elongation”) in duplex cords according to the invention advantageously excellently matches the values obtained for the triplex cords from the prior art. It is also evident here from table 1 that the overall diameter of the duplex cord according to the invention is significantly below the overall diameter of the reference system and that accordingly a thinner ply thickness can be established with the same amount of rubber coating over the cord. The duplex cord according to the invention is easier and more cost-effective to produce here because of the one-stage manufacturing process (“twist-process”) used.

In the light of the data shown in table 1 below, it is also evident to a person skilled in the art that, with duplex cords according to the invention, for the same overall diameter, reinforcing cords could also be obtained which have a higher modulus than the corresponding triplex cord.

TABLE 1

| | Unit | V1 | E2 |
|---|---|---|---|
| Yarns | — | 1680 × 2 | 1610 × 1 |
| | | (aramid) + | (HM aramid) + |
| | | 470 × 1 (nylon) | 1400 × 1 (nylon) |
| EPDM | — | 80 | 90 |
| LASE 2% | N | 36 | 31 |
| | N/cm | 288 | 279 |
| LASE 4% | N | 122 | 107 |
| | N/cm | 976 | 963 |
| Diameter | mm | 0.90 | 0.75 |
| Spacing | mm | 0.35 | 0.36 |
| Ply thickness | mm | 1.30 | 1.15 |
| Rubber over cord | mm | 0.20 | 0.20 |
| Twist | T/m | 320 | 361 |
| Twist factor | — | 198 | 198 |
| Twist process | — | 2 steps | 1 step |
| Linear density | — | 7.14 | 1.15 |
| quotient X | | | |

1.-10. (canceled)

11. A duplex cord for use as strength member in a belt bandage of a pneumatic vehicle tire, the cord comprising:
two yarns that are twisted together at the ends;
the first yarn has a Z value of 600 mN/tex or more;
the second yarn has a Z value of 75 mN/tex or less and a Y value of 150 mN/tex or less;
where Z is the force normalized to the linear yarn density at which an elongation of 1% is obtained in the force-elongation diagram;
where Y is the force normalized to the linear yarn density at which an elongation of 4% is obtained in the force-elongation diagram; and
where the quotient X of the linear density of the first yarn divided by the linear density of the second yarn is in the range from 1.0 to 1.3.

12. The duplex cord of claim 11, wherein the quotient X of the linear density of the first yarn divided by the linear density of the second yarn is in the range from 1.05 to 1.25, preferably in the range from 1.1 to 1.2, particularly preferably in the range from 1.13 to 1.17.

13. The duplex cord of claim 11, wherein the first yarn has a Z value of 650 mN/tex or more, preferably 700 mN/tex or more.

14. The duplex cord of claim 11, wherein the first yarn comprises a material selected from the group consisting of aromatic polyamides, in particular poly(p-phenyleneterephthalamide), and polyoxazoles, in particular poly(p-phenylene-2,6-benzobisoxazole), the first yarn preferably consisting of this material.

15. The duplex cord of claim 11, wherein the first yarn has a linear density in the range from 1000 to 3000 dtex, preferably in the range from 1500 to 2000 dtex.

16. The duplex cord of claim 11, wherein the second yarn has a linear density in the range from 1000 to 2000 dtex, preferably in the range from 1300 to 1700 dtex.

17. The duplex cord of claim 11, further comprising:
a composite material comprising the duplex cord at least partially covered by a crosslinkable rubberization mixture.

18. The duplex cord of claim 17, wherein the composite material is vulcanized.

19. A vehicle tire comprising:
a plurality of duplex cords employed in composite material;
the plurality of cords each comprising:
two yarns that are twisted together at the ends;
the first yarn has a Z value of 600 mN/tex or more;
the second yarn has a Z value of 75 mN/tex or less and a Y value of 150 mN/tex or less;
where Z is the force normalized to the linear yarn density at which an elongation of 1% is obtained in the force-elongation diagram;
where Y is the force normalized to the linear yarn density at which an elongation of 4% is obtained in the force-elongation diagram; and
where the quotient X of the linear density of the first yarn divided by the linear density of the second yarn is in the range from 1.0 to 1.3.

20. The tire of claim 19, further comprising a belt bandage having the plurality of cords.

21. A duplex cord for use as strength member in a belt bandage of a pneumatic vehicle tire, the cord comprising:
two yarns comprising a first yarn and a second yart that are twisted together at the ends;
the first yarn is a high-modulus yarn and has a Z value of 600 mN/tex or more;
the second yarn is a low-modulus yarn and has a Z value of 75 mN/tex or less and a Y value of 150 mN/tex or less;
the first yarn and the second yarn have matched linear densities to force-elongation characteristics;
where Z is the force normalized to the linear yarn density at which an elongation of 1% is obtained in the force-elongation diagram;
where Y is the force normalized to the linear yarn density at which an elongation of 4% is obtained in the force-elongation diagram;
where the quotient X of the linear density of the first yarn divided by the linear density of the second yarn is in the range from 1.13 to 1.17;
the first yarn has a Z value of 700 mN/tex or more;
the first yarn comprises a material selected from the group consisting poly(p-phenyleneterephthalamide), and polyoxazoles, in particular poly(p-phenylene-2,6-benzobisoxazole);
the first yarn has a linear density in the range from 1500 to 2000 dtex; and
the second yarn has a linear density in the range from 1300 to 1700 dtex.
